(19) United States
(12) Patent Application Publication
(10) Pub. No.: US 2013/0079909 A1
(43) Pub. Date: Mar. 28, 2013

(54) AUDIO OUTPUTTING APPARATUS AND PROGRAM OF THE SAME

(71) Applicant: Shuntaro KASHI, Osaka (JP)

(72) Inventor: Shuntaro KASHI, Osaka (JP)

(73) Assignee: ONKYO CORPORATION, Osaka (JP)

(21) Appl. No.: 13/472,671

(22) Filed: May 16, 2012

(30) Foreign Application Priority Data
Sep. 22, 2011 (JP) 2011-206680

(51) Int. Cl. G06F 17/30

(52) U.S. Cl. 700/94

(57) ABSTRACT

When a media player reproduces a content identical to a content being reproduced by a renderer, the media player obtains, from the media renderer, content information of the content being reproduced by the media renderer. The media player then obtains a content list from a server, and specifies a content having content information identical to content information received from the media renderer as well as its position in the content list. As a result, a user can specify the content being reproduced by the media renderer, and can start reproduction without operating the media player and searching for the content.

### BACKGROUND OF THE INVENTION

1. Field of the Invention

The present invention relates to an audio output apparatus for reproducing a content in a home network.

2. Description of the Related Art

In recent years, the following forms are becoming widespread. One form is such that a home network is structured, and music, still images, and moving image contents (hereinafter, contents) saved in a digital media server (hereinafter, DMS) are reproduced by a digital media renderer (hereinafter, DMR) according to an instruction of a digital media controller (hereinafter, DMC). Another form is such that a digital media player (hereinafter, DMP) obtains contents from the DMS and reproduces the contents. In a DLNA (registered trademark: hereinafter, DLNA) standard, functions of the DMP, DMS, DMR and DMC are defined so that specifications of communication and operations therebetween are determined. In the following description, the contents are music contents.

When the contents saved in the DMS are reproduced by an apparatus having the DMP function, a user views the contents of the DMS displayed on a display device connected to the DMP, and selects a content desired to be reproduced so as to instruct reproduction. The DMP requests the DMS for content data instructed to be reproduced by the user, and starts the reproduction.

On the other hand, when the contents saved in the DMS are reproduced by the apparatus having the DMR function, the user selects one DMS from a plurality of DMSs displayed on the display device connected to the DMC. Further, the user specifies one DMR from a plurality of DMRs as a reproducing apparatus in the DMC. The user specifies a content to be reproduced from the contents of the DMS displayed in the DMC. As a result, the instruction for reproducing contents is transmitted from the DMC to the DMR, and the DMR connects to the DMS specified by the DMC, and obtains content data of the DMS so as to reproduce the content data.

Further, some audio output apparatuses compatible with DLNA that can function as the DMP and also as the DMR are present. The audio output apparatus that can use the DMP function and the DMR function simultaneously has two or more audio output paths and audio amplifiers. A speaker for outputting contents reproduced by the DMR, and a speaker for outputting contents reproduced by the DMP are installed in separate rooms, and the reproduction by means of the DMR and the reproduction by means of the DMP can be simultaneously performed. At this time, a content that is identical to a content being reproduced by the DMR is desired to be easily reproducible by using the DMP.

When the content being reproduced by the DMR is automatically specified by the DMP and is reproduced, the DMP has a problem that even when a content URL (location information about the content of DMS) utilized by the DMR is used, the content that is identical to the content being reproduced by the DMR cannot be reproduced. This is because the content URL of the DMS used for the reproduction by the DMR is specified by the DMC, and the DMP cannot use this directly.

Further, the DMP cannot automatically specify a location including hierarchical information of the DMS in the content being reproduced by the DMR. Therefore, in the DMP, the user cannot automatically obtain a higher folder of the content being reproduced by the DMR. The higher folder is an album folder or an artist folder to which the content being reproduced by the DMR belongs. The URL of the content, which is received by the DMR when the DMC instructs the reproduction, does not include at all information or the like about a higher folder to which the content belongs. Therefore, the user operates the DMP with reference to the artist name or the album name of the content being reproduced by the DMR, and should search for the artist folder or the album folder including the content being reproduced by the DMR.

### SUMMARY OF THE INVENTION

The present invention is devised in order to solve the above problems, and an object thereof is that a DMP reliably specifies and reproduces a content, the content identical to a content being reproduced by a DMR, and the DMP specifies a folder of a DMS including the content identical to the content being reproduced by the DMR, and automatically moves to that folder so as to reproduce the content.

An audio output apparatus of the present invention comprises: a media renderer for obtaining and reproducing a content of a server based on a control command transmitted from a controller according to a user's operation; and a media player for obtaining and reproducing the content of the server based on an instruction input by the user. The media renderer includes a unit for receiving location information of the content of the server from the controller and obtaining the content from the server based on the location information so as to reproduce the content. The media player includes a unit for obtaining a content list of the server selected by the user's operation, a reproducing unit for obtaining the content selected from the content list by the user's operation from the server so as to reproduce the content, a unit for accepting an identical content reproducing instruction that is an instruction for reproducing the content identical to the content being reproduced by the media renderer, a content information obtaining unit for obtaining, from the media renderer, content information of the content being reproduced by the media renderer when the identical content reproducing instruction is accepted, and an identical content specifying unit for searching the content list for a content identical to the content being reproducing by the media renderer based on the content information and specifying a position of the content in the content list, and the reproducing unit reproduces the content specified by the identical content specifying unit.

When the media player accepts an instruction for reproducing a content that is identical to the content being reproduced by the media renderer, the media player obtains, from the media renderer, information about a content being reproduced by the media renderer. Further, the media player obtains a content list from the server and specifies from the content list a content having the content information identical to the content information received from the media renderer. As a result, the user can specify the content being reproduced by the media renderer from the content list, and can reproduce the content without the user's operation of the media player to search for the content from the server.

Preferably the audio output apparatus further comprising: a first output section for outputting content data being reproduced by the media player to a first content receiving device installed in a first room; and a second output section for outputting the content data being reproduced by the media renderer to a second content receiving device installed in a second room. When the media player accepts the identical content reproducing instruction, the reproducing unit outputs the content specified by the identical content specifying unit to the first content receiving device.

The media renderer reproduces a content in the content receiving device arranged in a second room, and simultaneously, the media player can reproduce a content identical to the content being reproduced by the media renderer from the content receiving device arranged in a first room.

Preferably the content information is meta-information of the content, the media player further includes a determining unit for comparing the meta-information of each of the contents in the content list with the meta-information obtained from the media renderer to determine whether the meta-information match with each other when the identical content reproducing instruction is accepted, and the identical content specifying unit specifies a position of the content whose meta-information is determined as matching in the content list.

The media player searches for the content identical to the content being reproduced by the media renderer using meta-information about the content. As a result, the user can specify the content being reproduced by the media renderer from the content list and can start the reproduction without operating the media player to search for the content from the server.

Preferably the content information includes folder meta-information as the meta-information about one or a plurality of content folders and content meta-information as the meta-information about the content included in a content folder in a lowest hierarchical level. The media player further includes a folder list obtaining unit for obtaining a content folder list from the server, a content folder determining unit for comparing the meta-information about the content folders in the content folder list with the folder meta-information obtained from the media renderer to determine whether the meta-information match with each other, an identical content folder specifying unit for specifying a position of the content folder whose meta-information is determined as matching in the folder list, and a content path storage unit for storing the position of the content folder specified by the identical content folder specifying unit into a content path, the determining unit compares the meta-information about the contents included in the lowest content folder with the content meta-information obtained from the media renderer to determine whether the meta-information match with each other, the identical content specifying unit specifies a position of the content whose meta-information is determined as matching in the content list, the content path storage unit stores the position of the content specified by the identical content specifying unit into the content path, the reproducing unit moves to the content folder of the server specified by the content path to reproduce the content.

The media player specifies the content identical to the content being reproduced by the media renderer based on the meta-information about the folder and the meta-information about the content. Therefore, the media player can specify the content as well as path information of the folder on the server. As a result, in the media player, the user can easily obtain an album folder and an artist folder including the content being reproduced by the media renderer.

Preferably the media player further includes a content meta-information missing determining unit for determining whether the content information includes the content meta-information, and a content data obtaining unit for, when the identical content reproducing instruction is accepted, obtaining from the media renderer at least part of the content data of the content being reproduced by the media renderer, when the determination is made that the content meta-information is missing, at least part of the content data of the respective contents included in the lowest content folder is obtained from the server, the determining unit compares a reproducing waveform of the content data of the content obtained from the server with a reproducing waveform of the content data obtained from the media renderer to determine whether the content data match with each other, and the identical content specifying unit specifies a position of the content whose content data is determined as matching in the content list.

According to the present embodiment, even when the meta-information about the content cannot be obtained from the media renderer, the media player compares the content data of the content in the content folder and the content data of the content being reproduced by the media renderer, so that the media player can uniquely specify the content being reproduced by the media renderer.

A media renderer program stored on a non-transitory computer readable medium causes the audio output apparatus to execute the respective units of the media renderer in the audio output apparatus.

A media player program stored on a non-transitory computer readable medium causes the audio output apparatus to execute the respective units of the media player in the audio output apparatus.

### BRIEF DESCRIPTION OF THE DRAWINGS

FIG. 1 is a connection diagram of an audio output apparatus, a DMS, and a DMC according to a preferred embodiment of the present invention;

FIG. 2 is a block diagram illustrating an apparatus according to the preferred embodiment of the present invention;

FIG. 3 is a diagram illustrating a structure of contents to be managed by a DMS;

FIG. 4 is a flowchart illustrating a process in a control section of a DMC;

FIG. 5 is a flowchart illustrating a process in a control section of a DMR;

FIG. 6 is a flowchart illustrating a process in a control section of a DMP;

FIG. 7 is a flowchart illustrating a process in the control section of the DMR;

FIG. 8 is a flowchart illustrating a process in the control section of the DMP;

FIG. 9 is a diagram illustrating a structure of contents to be managed by the DMS;

FIG. 10 is a flowchart illustrating a process in the control section of the DMR;

FIG. 11 is a flowchart illustrating a process in the control section of the DMP;

FIG. 12 is a diagram illustrating a structure of contents to be managed by the DMS;

FIG. 13A is a flowchart illustrating a process in the control section of the DMP;

FIG. 13B is a flowchart illustrating a process in the control section of the DMP; and

FIG. 14 is a flowchart illustrating a process in the control section of the DMP.

### DETAILED DESCRIPTION OF THE PREFERRED EMBODIMENTS

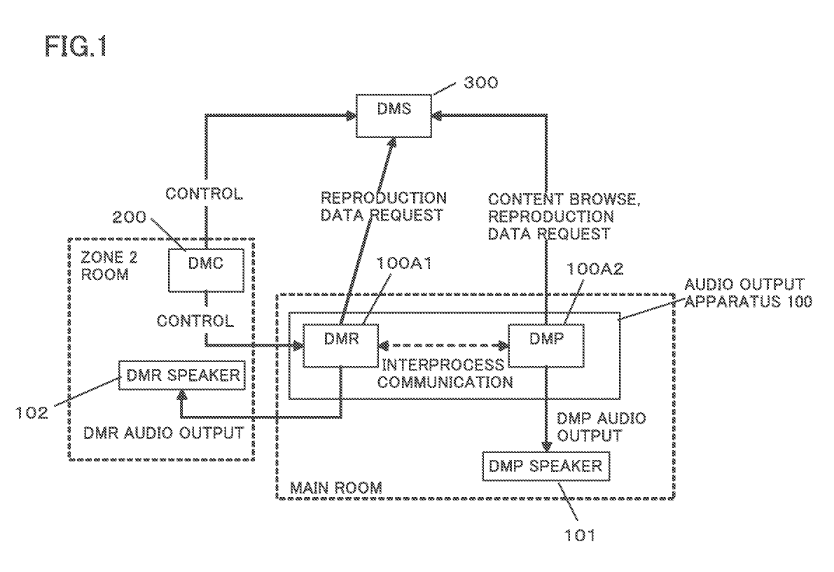

A communication apparatus according to preferred embodiments of the present invention will be concretely described below with reference to the drawings, but the present invention is not limited to these preferred embodiments. FIG. 1 is a connection diagram of an audio output apparatus, a DMS, and a DMC according to the preferred embodiment of the present invention.

An audio output apparatus 100 that has functions of a DMR 100A1 and a DMP 100A2, a DMC 200, and a DMS 300 are connected to a network. A DMP speaker 101 and a DMR speaker 102 are connected to the audio output apparatus 100. In a home network in FIG. 1, the audio output apparatus 100 and the DMP speaker 101 are installed in a main room, and the DMC 200 and the DMR speaker 102 are installed in a zone 2 room. The DMS 300 is installed in any one of the main room and the zone 2 room, or any place other than the main room and the zone 2 room. Since the DMR 100A1 and the DMP 100A2 are incorporated into the one audio output apparatus 100, they can communicate with each other without using the network, and data can be exchanged and referred to by interprocess communication and a shared memory. Further, the audio output apparatus 100 can output a sound to the DMP speaker 101 and the DMR speaker 102 simultaneously. The audio output apparatus is, for example, an AV amplifier.

The DMR 100A1 receives a reproducing instruction from the DMC 200, and connects to the DMS 300 according to the reproducing instruction. The DMR 100A1 obtains content data from the DMS 300 so as to reproduce the content data. When the DMR 100A1 receives the reproducing instruction from the DMC 200, only the URL of the content of the DMS 300 is specified. That is, the DMR 100A1 does not have a folder structure and hierarchical information of the DMS 300 unlike the DMP 100A2, described later. When the DMR 100A1 completes the reproduction of the content specified by the DMC 200, the completion is notified to the DMC 200. The DMC 200 transmits, to the DMR 100A1, a URL of a content to be reproduced next. The DMR 100A1 accesses the URL of the content to be transmitted from the DMC 200, and reproduces the content.

The DMP 100A2 browses a folder list stored in the DMS 300. The folder is a storage place including reproducible contents, and the folder list is a row of folders. The folder includes a plurality of types of folders such as an artist folder, an album folder, a genre folder, and an all track folder. The artist folder includes an album folder list, and the album folder includes reproducing contents. For example, the user selects a specific artist from an artist folder list, and obtains the album list included in the artist folder. The user selects a specific album from the album list, and obtains a content list in the album. The user specifies a content from the content list. The DMP 100A2 reproduces the specified content. After the reproduction of the content is completed, the DMP reproduces next content included in the album folder or the artist folder including the reproduced content.

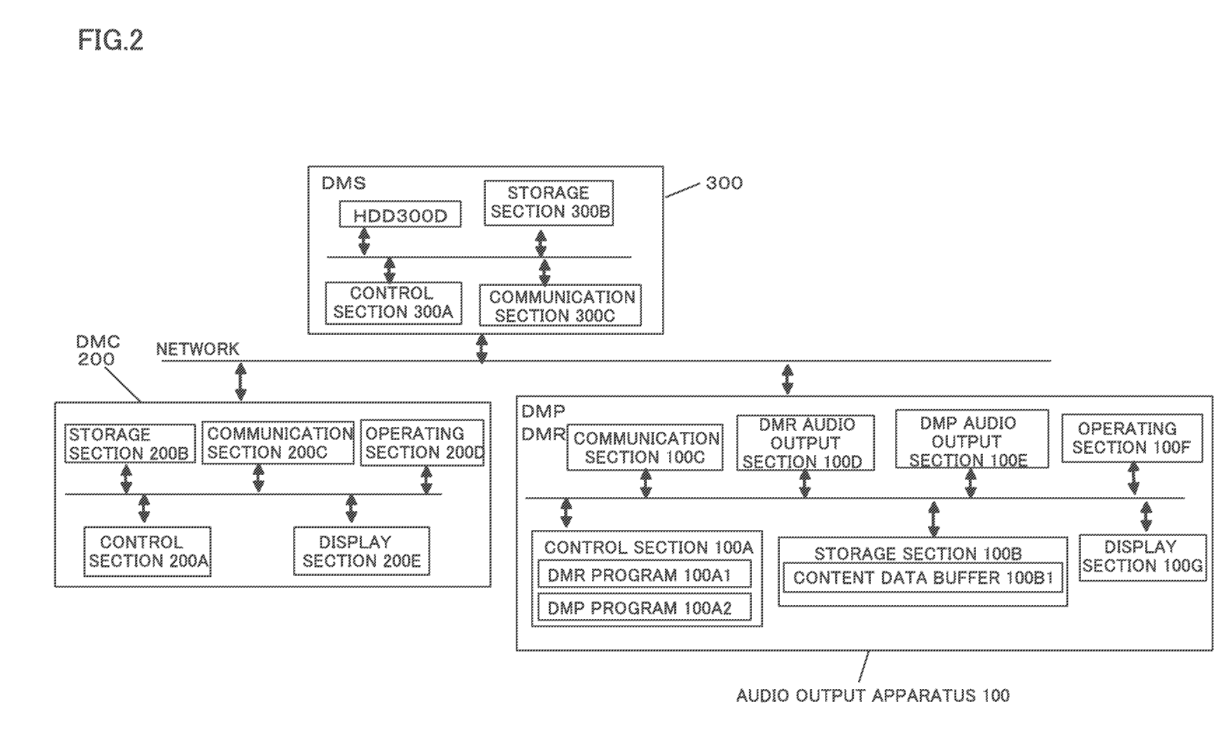

FIG. 2 is a block diagram illustrating respective devices connected to the network. The audio output apparatus 100 has a control section 100A, a storage section 100B, a communication section 100C, a DMR audio output section 100D, a DMP audio output section 100E, an operating section 100F, and a display section 100G.

The control section 100A controls the audio output apparatus 100 and is, for example, a microcomputer or a CPU. The control section 100A further has a DMR program 100A1 and a DMP program 100A2. The DMR program 100A1 is a program executed by the control section 100A when the audio output apparatus 100 operates as the DMR. The DMP program 100A2 is a program executed by the control section 100A when the audio output apparatus 100 operates as the DMP. The control section 100A can execute the DMR program 100A1 and the DMP program 100A2 simultaneously. Hereinafter, when they do not have to be particularly clarified as a program and only a function thereof is indicated, the DMR program 100A1 is called the DMR 100A1, and the DMP program 100A2 is called the DMP 100A2.

The storage section 100B is, for example, a ROM or a RAM. The storage section 100B has a content data buffer 100B1. The content data buffer 100B1 is a buffer for storing all or part of content data obtained from the DMS 300 for reproduction by the DMR 100A1.

The communication section 100C has a function for transmitting/receiving data with the DMC 200 and the DMS 300 via the network.

When the audio output apparatus 100 function as the DMR, the DMR audio output section 100D outputs a sound to the DMR speaker 102 of FIG. 1. The DMR audio output section 100D is configured by a decoder, a DAC, and an audio signal amplifying section. When the audio output apparatus 100 functions as the DMP, the DMP audio output section 100E outputs a sound to the DMP speaker 101 of FIG. 1. The DMP audio output section 100E is configured by a decoder, a DAC, and an audio signal amplifying section. As described above, since the audio output apparatus 100 can simultaneously execute the DMR program 100A1 and the DMP program 100A2, a sound can be simultaneously output from the DMR audio output section 100D and the DMP audio output section 100E. The sounds that are output from both the output sections may be the same as or different from each other.

The operating section 100F is a section for receiving an input from an input button provided to a main body of the audio output apparatus 100 and a remote control code transmitted from a remote controller attached to the audio output apparatus 100. A command received from the user by the operating section 100F is analyzed and executed in the control section 100A.

The display section 100G displays information about a content being reproduced by the audio output apparatus 100. The display section 100G is, for example, an FL tube or an OSD (onscreen display).

The DMC 200 includes a control section 200A, a storage section 200B, a communication section 200C, an operating section 200D and a display section 200E.

The control section 200A controls the DMC 200, and is, for example, a microcomputer or a CPU. The storage section 200B is, for example, a ROM or a RAM. The communication section 200C communicates with the AV amplifier 100 and the DMS 300 via the network. The operating section 200D is a part that accepts an operation for the DMC 200 and receives an input from a button arranged on the DMC 200 and a remote control code transmitted from a remote controller attached to the DMC 200. The display section 200E displays a content list obtained from the DMS 300 by the DMC 200, a reproducing state of a content received from the DMR 100A1, and a list of reproducing devices having the DMR function on the network.

The DMS 300 includes a control section 300A, a storage section 300B, a communication section 300C, and an HDD 300D.

The control section 300A controls the DMS 300, and is, for example, a microcomputer or a CPU. The control section 300A executes a process for transmitting a content list and content data in response to a content list obtaining request from the DMC 200 or the DMP 100A2, and a content data obtaining request from the DMR 100A1 or the DMP 100A2. The storage section 300B is, for example, a ROM or a RAM. The communication section 300C communicates with the audio output apparatus 100 and the DMC 200 via the network. The HDD 300D is a storage medium for storing music contents or the like.

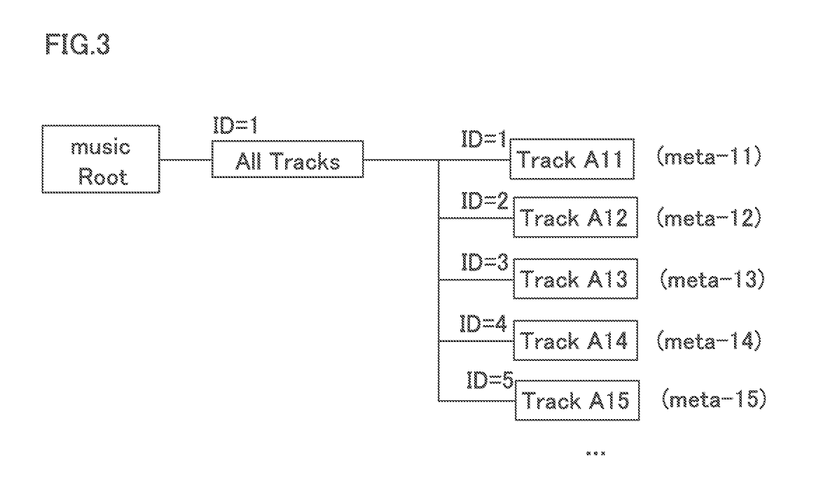

FIG. 3 illustrates one example of the content list stored in the HDD 300D of the DMS 300. In the DMS 300, contents are hierarchically managed, and a folder “All Tracks” including all content data stored in the HDD 300D exists below the highest hierarchical level “musicRoot”. An identification number (hereinafter, content ID) is set for the folder “All Tracks”. Contents are arranged in a lower hierarchical level below the folder “All Tracks” (Track A11, Track A12, and the like). Content IDs are also given to the respective contents. The DMP 100A2 can specify contents using the contents IDs.

The control section 100A of the audio output apparatus 100 in the present invention first starts to execute the DMR program 100A1. The DMR 100A1 obtains from the DMS 300 a content instructed to be reproduced by the DMC 200, and starts the reproduction. The content is reproduced from the DMR speaker 102 installed in the zone 2 room. The control section 100A of the audio output apparatus 100 then executes the DMP program 100A2 according to a user's operation or the like. The user instructs the DMP 100A2 to reproduce the content identical to the content being reproduced by the DMR 100A1. The control section 100A specifies the content identical to the content being reproduced by the DMR 100A1, and starts the reproduction in the DMP 100A2. Content data reproduced by the DMP 100A2 is output from the DMP speaker 101 of the main room. The DMP 100A2 continues the reproduction according to the content list shown in FIG. 3.

[First Embodiment in which DMP Starts Reproduction of Content Identical to that of DMR]

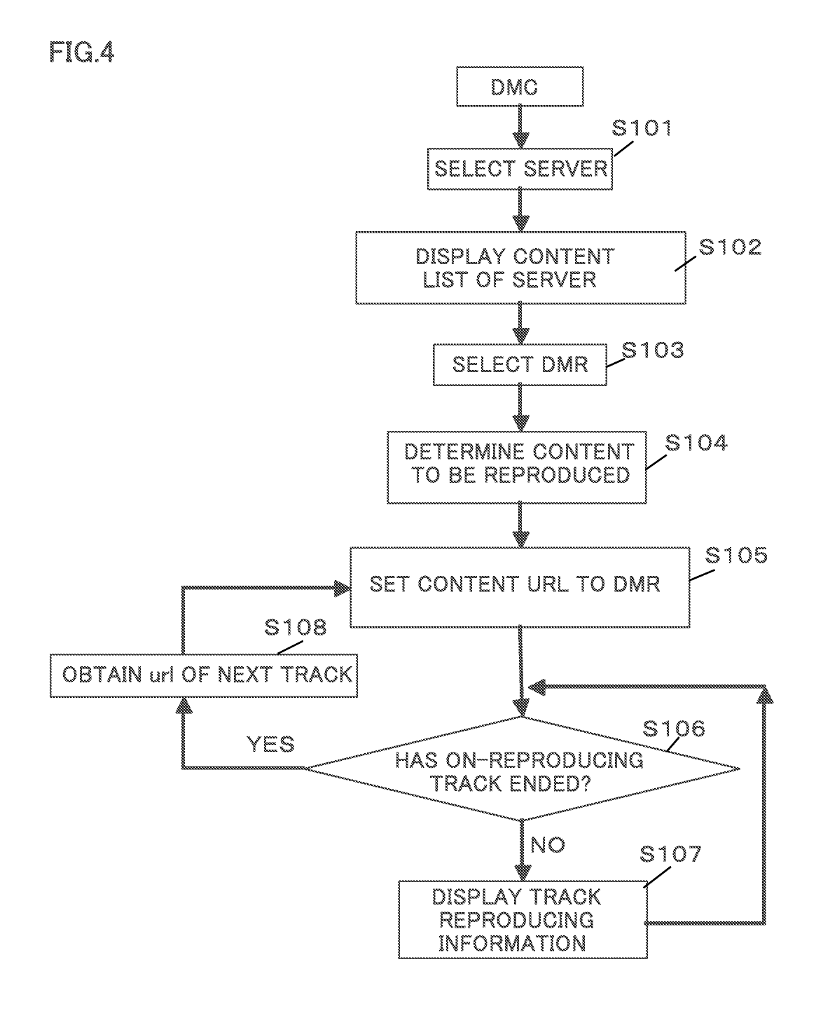

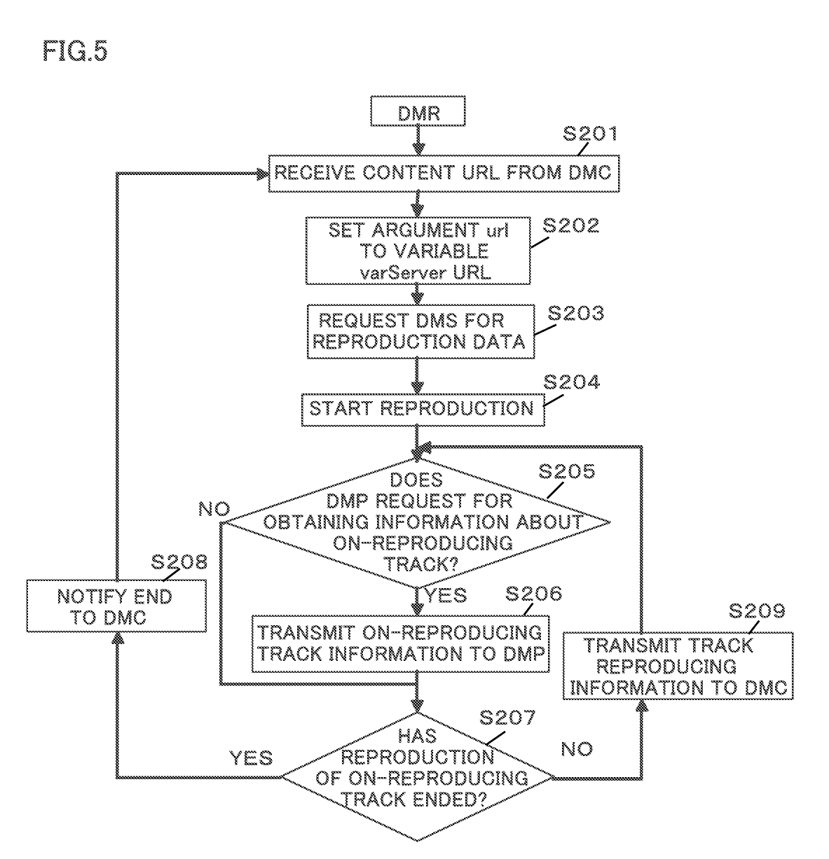

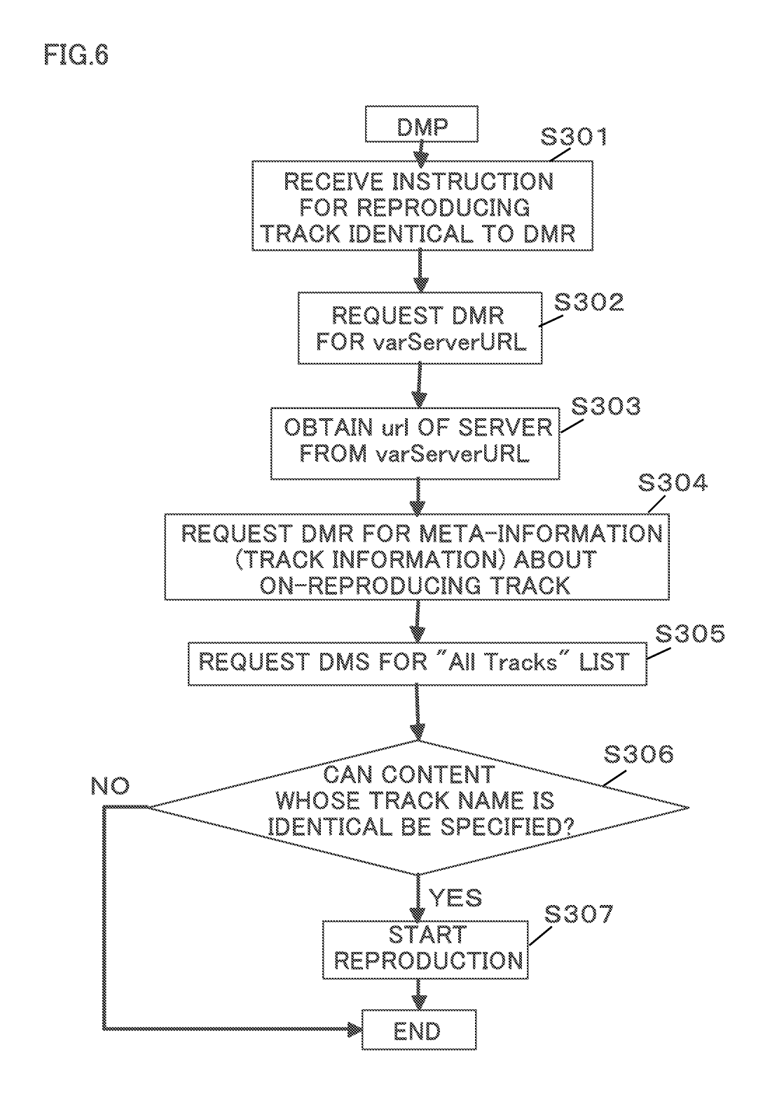

FIG. 4 is a flowchart illustrating a process executed by the DMC 200 in the first embodiment when the DMP 100A2 is instructed to reproduce the content identical to that of the DMR 100A1. FIG. 5 is a flowchart illustrating the DMR 100A1 in the first embodiment. FIG. 6 is a flowchart illustrating the DMP 100A2 according to the first embodiment.

According to the present embodiment, when the DMP 100A2 receives an instruction for reproducing the content identical to that of the DMR 100A1, the DMP 100A2 specifies a content having content information identical to the content information of the content being reproduced by the DMR 100A1 from the contents stored in the DMS 300.

The DMC 200 in the flowchart of FIG. 4 searches for the DMS 300 on the network and displays the searched DMS 300 on the display section 200E. When a plurality of devices having the DMS function is present on the network, all the DMSs 300 are displayed on the display section 200E. Then, one DMS 300 is selected in the DMC 200 by the user's operation (S101).

The DMC 200 connects to the DMS 300 selected in S101, and obtains and displays a list of the contents stored and managed in the DMS 300 (S102). The contents are displayed on the display section 200E as the content list positioned in the “All Tracks” folder or in a lower hierarchical level below the “All Tracks” folder in FIG. 3.

The DMC 200 searches for the DMR 100A1 on the network, and displays the searched DMRs 100A1 on the display section 200E. The user specifies one DMR 100A1 from the DMR list in the DMC 200 (S103).

The DMC 200 specifies a content to be reproduced from the content list displayed by the user's operation in S102 (S104).

The DMC 200 sets URL of the content specified in S104 to the DMR 100A1 (S105). The URL of the content is location information about the content selected by the user on the DMS 300. The DMR 100A1 accesses to the content URL transmitted from the DMC 200 by the process in S105, and obtains the content data from the DMS 300 so as to reproduce the content data.

The DMC 200 determines whether the DMR 100A1 completed the reproduction of an on-reproducing track (S106). When the reproduction of the currently on-reproducing content is ended, the DMR 100A1 notifies the end of the reproduction to the DMC 200. Therefore, the DMC 200 can obtain the reproducing state of the content in the DMR 100A1. When the DMC 200 determines that the DMR 100A1 completes the reproduction (YES in S106), the DMC 200 obtains an URL of the next content in the content list of the DMS 300 held by the DMC 200 (S108), and executes the process in S105. When the DMC 200 determines that the DMR 100A1 is reproducing the content (NO in S106), the reproducing state in the DMR 100A1 is displayed on the display section 200E of the DMC 200 (S107). The reproducing state in the DMR 100A1 includes a status such as reproducing, pause, or stop, the number of progress seconds of the on-reproducing content, and meta-information about the on-reproducing content. The status and the number of progress seconds are displayed on the display section 200E based on information to be transmitted to the DMC 200 by the DMR 100A1. After the DMC 200 executes the process in S107, the DMC 200 again executes the process in S106.

The DMR 100A1 in the flowchart of FIG. 5 receives the URL transmitted in S105 in FIG. 4 (S201). The DMR 100A1 stores the URL received in S201 (S202). The URL received in S201 is a URL of a content of the DMS 300 as destination to which the DMR 100A1 requests to distribute the content.

The DMR 100A1 requests the DMS 300 to distribute the content using the URL received in S201 (S203). The DMR 100A1 reproduces the content data distributed from the DMS 300 (S204).

The DMR 100A1 determines whether the request for transmitting the content information of the content being reproduced by the DMR 100A1 is received from the DMP 100A2 (S205). The content information includes a track name of the content or the like. When the DMR 100A1 determines that the request for the content information is not received from the DMP 100A2 (NO in S205), the DMR 100A1 determines whether the reproduction of the on-reproducing content is completed (S207). When the DMR 100A1 determines that the request for the content information is received from the DMP 100A2 (YES in S205), the information about the on-reproducing content is transmitted to the DMP 100A2 (S206).

When the DMR 100A1 determines that the reproduction of the on-reproducing content is completed (YES in S207), the DMR 100A1 notifies the completion of the content reproduction to the DMC 200 (S208). When the DMR 100A1 determines that the reproduction of the on-reproducing content is not completed (NO in S207), the DMR 100A1 transmits a reproduction status and progress information about the reproduction to the DMC 200 (S209).

The DMP 100A2 in the flowchart of FIG. 6 receives an instruction for starting the reproduction of the content identical to the content being reproduced by the DMR 100A1 according to the user's operation (S301). This instruction is carried out by the user operating the operating section 100F of the DMP 100A2.

The DMP 100A2 requests the DMR 100A1 for information about the DMS 300 as destination to which the DMR 100A1 accepts the distribution of the content (S302). Since the URL obtained by the process in S302 is a URL for reproducing the content, it also includes information other than an IP Address of the DMS 300. Therefore, the DMP 100A2 fetches the IP Address of the DMS 300 from the URL received from the DMR 100A1 (S303).

The DMP 100A2 requests the DMR 100A1 for information about the content being reproduced by the DMR 100A1 (S304).

The DMP 100A2 connects to the DMS 300 specified in S303, and requests for the “All Tracks” list (S305). The “All Tracks” list is a list of tracks such as Track A11 and Track A12 in FIG. 3. In general, since the DMS 300 stores a plurality of contents, the list of the plurality of contents can be obtained in S305.

The DMP 100A2 determines whether the content information obtained in S304 matches with the content information about each of the contents in the content list obtained in S305. When the DMP 100A2 determines that they match (YES in S306), the DMP 100A2 requests the DMS 300 for the content data of the content determined as matching, and starts the reproduction (S307). When the DMP 100A2 determines that a content having the content information matching with the content information obtained in S304 is not present in the content list obtained in S305 (NO in S306), the DMP 100A2 cannot specify the content that is identical to the content being reproduced by the DMR 100A1, and thus ends the process. After the reproduction of the content that is started in S307 is completed, the DMP 100A2 reproduces the next content according to the content list in FIG. 3. On the other hand, the DMR 100A1 reproduces the content according to the content list of the DMC 200. That is, the DMR 100A1 and the DMP 100A2 continue the reproduction according to the different content lists. The DMR 100A1 and the DMP 100A2 reproduce the content from speakers (the DMP speaker 101 and the DMR speaker 102) arranged in different rooms.

According to the first embodiment, when the DMP 100A2 receives the instruction for reproducing the content identical to that of the DMR 100A1, the DMP 100A2 automatically searches the DMS 300 for the content having the content information matching with the content information about the content being reproduced by the DMR 100A1, and starts the reproduction.

[Second Embodiment in which the DMP Starts the Reproduction of the Content Identical to that of DMR]

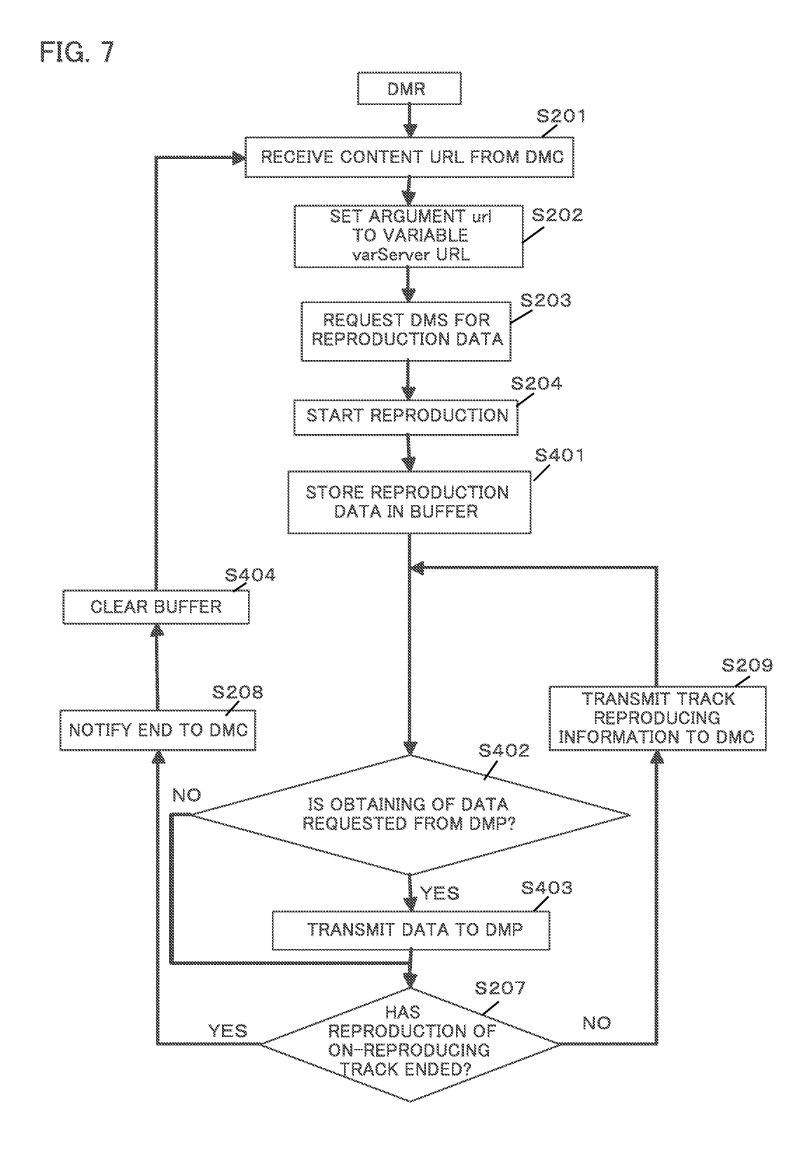

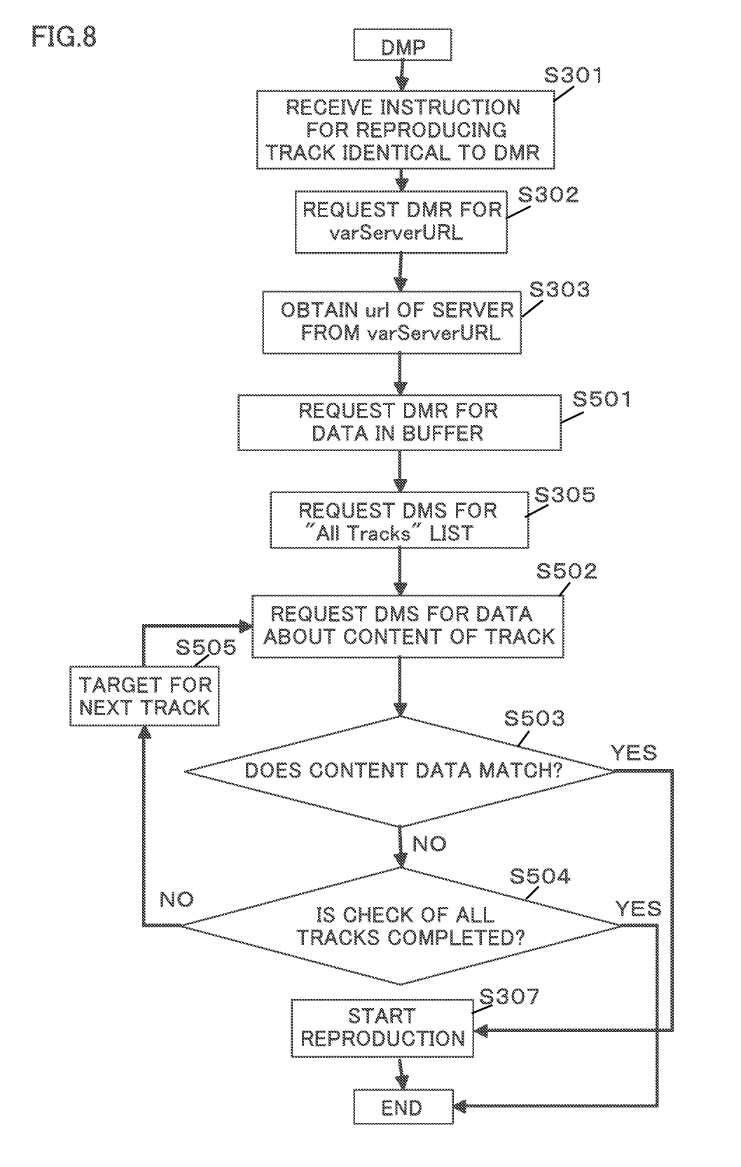

FIG. 7 is a flowchart illustrating the DMR 100A1. FIG. 8 is a flowchart illustrating the DMP 100A2. The DMP 100A2 in the second embodiment uses content data instead of content information for determining whether a content is identical to the content being reproduced by the DMR 100A1. In FIG. 7, the same processes as in FIG. 5 are denoted by the same reference symbols, and descriptions thereof will be omitted. In FIG. 8, the same processes as in FIG. 6 are denoted by the same reference symbols, and descriptions thereof will be omitted.

The DMR 100A1 in the flowchart of FIG. 7 receives a content instructed by the DMC 200 from the DMS 300, and starts the reproduction (S204). After the start of the reproduction, the DMR 100A1 stores the content data received from the DMS 300 for reproduction into the content data buffer 100B1 that is a temporary buffer (S401). The content data stored in the content data buffer 100B1 may have a size for enabling the determination that the two contents are identical. An example of such data is data for first 10 seconds of contents.

The DMR 100A1 determines whether the DMP 100A2 requests for obtaining content data (S402). When the determination is made that content data is not requested (NO in S402), the DMR 100A1 executes the process in S207. When the DMR 100A1 determines that the request for obtaining the content data is received (YES in S402), the DMR 100A1 transmits the content data in the content data buffer 100B1 to the DMP 100A2 (S403).

When the reproduction of the on-reproducing content is completed, the DMR 100A1 clears the content data buffer 100B1 (S404).

The DMP 100A2 in the flowchart of FIG. 8 obtains an IP Address of the DMS 300 according to the process in S303, and requests the DMR 100A1 to transmit the content data in the content data buffer 100B1 (S501).

The DMP 100A2 obtains the “All Tracks” list from the DMS 300 (S305), and requests the DMS 300 for content data of first 10 seconds of the respective contents included in the “All Tracks” list to obtain the content data (S502). The DMP 100A2 determines whether the content data obtained in S501 matches with the content data obtained in S502 (S503).

When the DMP 100A2 determines that the content data obtained in S501 matches with the content data obtained in S502 (YES in S503), the DMP 100A2 requests the DMS 300 for the matched content data of the content, and starts the reproduction (S307). When the DMP 100A2 determines that the content data obtained in S501 does not match with the content data obtained in S502 (NO in S503), the DMP 100A2 determines whether the processes in S502 and S503 are executed on all the contents in the content list obtained in S305 (S504). When the determination is made that not all the contents are checked (NO in S504), the next content in the “All Track” list is subject to the check (S505). When the DMP 100A2 determines that all the contents are checked (YES in S504), the DMP 100A2 determines that the content identical to the content being reproduced by the DMR 100A1 cannot be obtained, and ends the process (YES in S504).

According to the second embodiment, when the DMP 100A2 searches for the content identical to the content being reproduced by the DMR 100A1, the DMP 100A2 utilizes the content data so as to be capable of reliably determining whether the contents are identical to each other.

[Third Embodiment in which DMP Starts Reproduction of Content Identical to that of DMR]

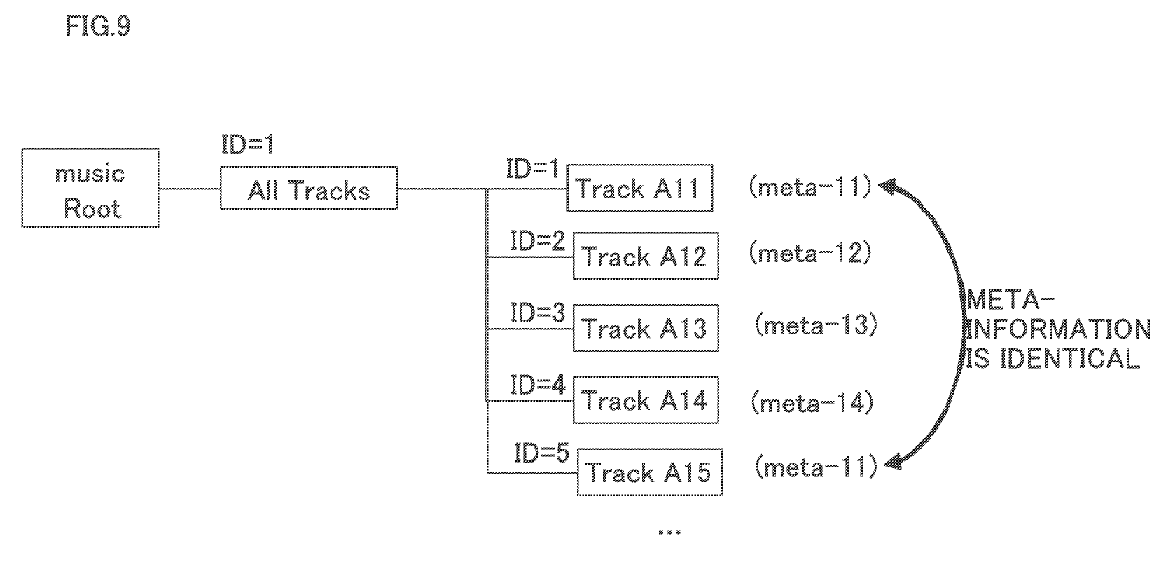

FIG. 9 illustrates a state where a plurality of contents whose content information is identical to each other is registered in “All Tracks” managed by the DMS 300. That is, Track All and Track A15 are different contents, but have identical content information (meta-information). In this case, the DMP 100A2 cannot specify only one content that is identical to the content being reproduced by the DMR 100A1 based on the content information. According to the second embodiment, content being reproduced by the DMR 100A1 can be specified uniquely, but since the DMP 100A2 obtains content data from the DMS 300 and compare the content data one by one (S502 and S503), the process takes a long time.

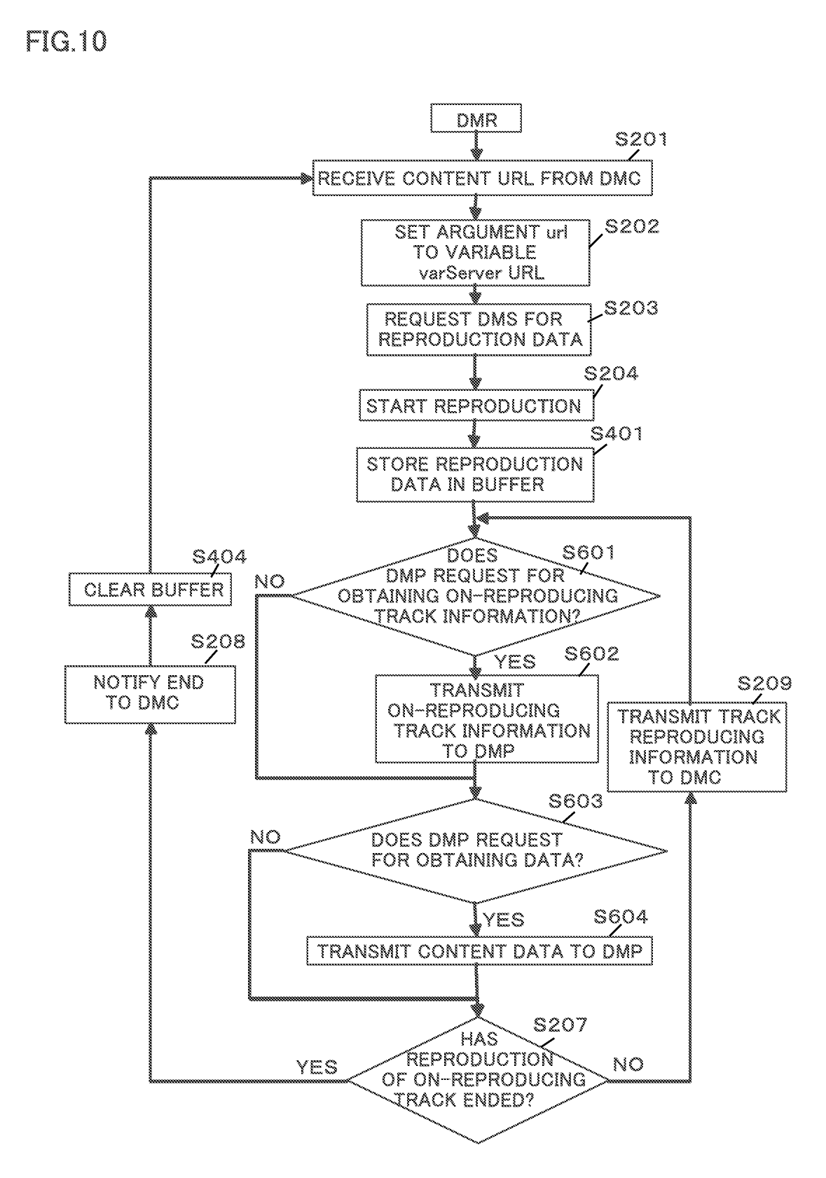

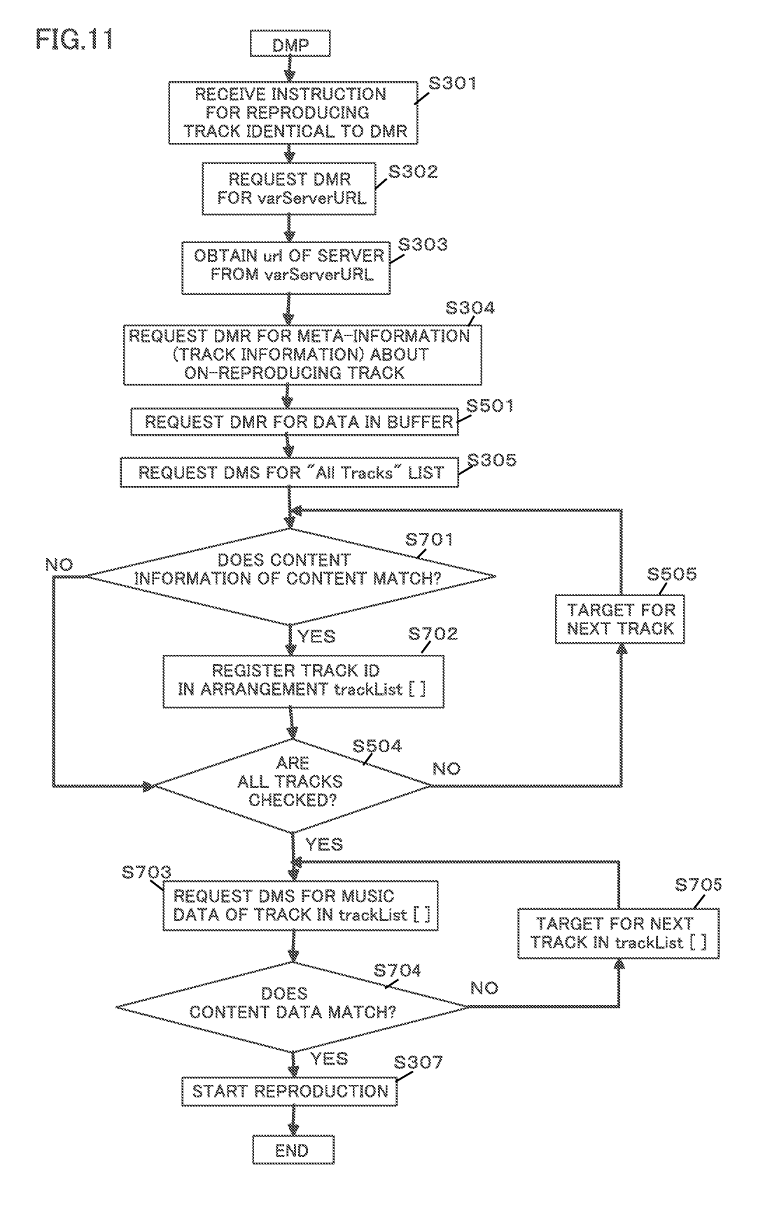

FIG. 10 is a flowchart illustrating the DMR 100A1 according to the third embodiment. FIG. 11 is a flowchart illustrating the DMP 100A2 according to the third embodiment. The DMP 100A2 in the third embodiment first uses content information for determining whether a content is identical to the content being reproduced by the DMR 100A1. The DMP 100A2 then determines, as to the contents whose content information is determined as matching with each other, whether their content data match with each other. In FIG. 10, the same processes as in FIG. 7 are denoted by the same reference symbols and descriptions thereof will be omitted. In FIG. 11, the same processes as in FIG. 8 are denoted by the same reference symbols and descriptions thereof will be omitted.

In the flowchart of FIG. 10, the DMR 100A1 starts the reproduction (S204), and stores data about the content started to be reproduced into the content data buffer 100B1 (S401). When the DMR 100A1 determines that a request for receiving the content information being reproduced by the DMR 100A1 is received from the DMP 100A2 (YES in S601), the on-reproducing content information is transmitted to the DMP 100A2 (S602), and when the determination is made that the request is not received (NO in S601), the process goes to S603.

When DMR 100A1 determines that the request for transmitting the content data is received from the DMP 100A2 (YES in S603), the content data of the content data buffer 100B1 is transmitted to the DMP 100A2 (S604), and when the determination is made that the request is not received (NO in S603), the process goes to S207.

In the flowchart of FIG. 11, the DMP 100A2 requests the DMR 100A1 for the content information about the content being reproduced by the DMR 100A1 and obtains the content information (S304). Further, the DMP 100A2 obtains the content data from the DMR 100A1 (S501). The DMP 100A2 then obtains the “All Tracks” list from the DMS 300 (S305).

The DMP 100A2 determines whether the content information about the content obtained in S305 matches with the content information obtained in S304 (S701). When they match with each other (YES in S701), the DMP 100A2 registers a matched content ID into an arrangement trackList [ ]. For example, the content ID of Track A13 is “1.3”. The first part “1” is a number indicating an “AllTracks” folder, and “.” indicates the hierarchical level. The last part “3” indicates a serial number of Track A13 in the “All Tracks” folder.

The DMP 100A2 determines whether the process in S701 is executed on all the contents obtained in S305 (S504), and when the determination is made that all the contents are checked (YES in S504), the DMP 100A2 requests the DMS 300 for the content data of the contents registered in the arrangement trackList [ ] (S703). The DMP 100A2 determines whether the respective contents registered in the arrangement trackList [ ] have content data matching with the content data obtained in the process in S501 (S704). When determined as not matching (NO in S704), the DMP 100A2 executes the process after S703 on the next content registered in the arrangement trackList [ ], and when determined as matching (YES in S704), the DMP 100A2 starts to reproduce the matched content (S307). The processes in S703 and in S704 may be executed only when two or more contents are registered in the arrangement trackList [ ].

According to the third embodiment, when the DMP 100A2 searches for a content identical to the content being reproduced by the DMR 100A1, the DMP 100A2 first specifies a content whose content information matches, and further specifies a content whose content data match. For this reason, even when a plurality of contents whose content information match are present, the DMP 100A2 can uniquely specify the content being reproduced by the DMR 100A1.

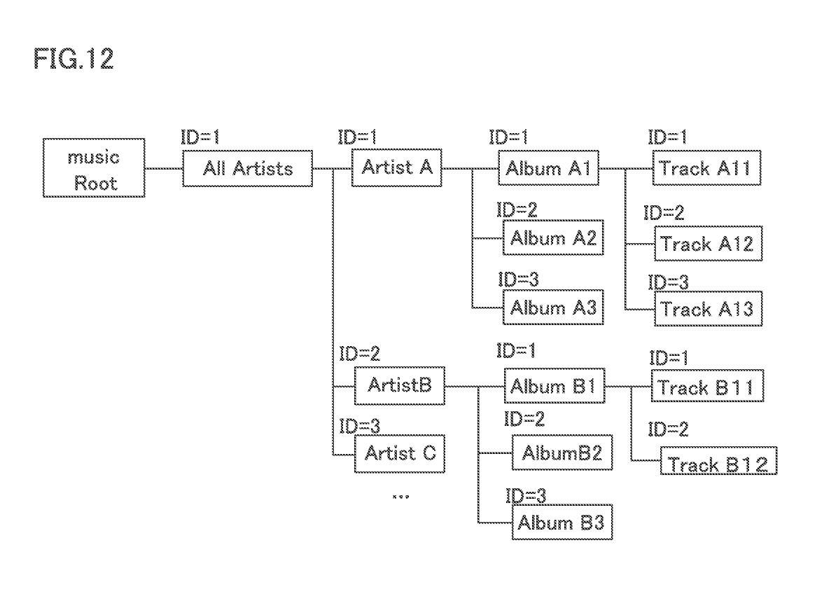

FIG. 12 illustrates another embodiment in which the DMS 300 manages contents. FIG. 12 illustrates a form where contents are managed for respective artists. An All Artists folder exists below the highest hierarchical level “musicRoot”. A list of artist folders for storing contents to be stored in the DMS 300 for respective artists exists on a lower hierarchical level below All Artists. An artist name is generally added to the artist folder. Further, a plurality of album folders exist in a lower hierarchical level below the artist folders, respectively. Further, contents (tracks) exist in a lower hierarchical level below the album folder.

[Fourth Embodiment in which DMP Starts Reproduction of Content Identical to that of DMR]

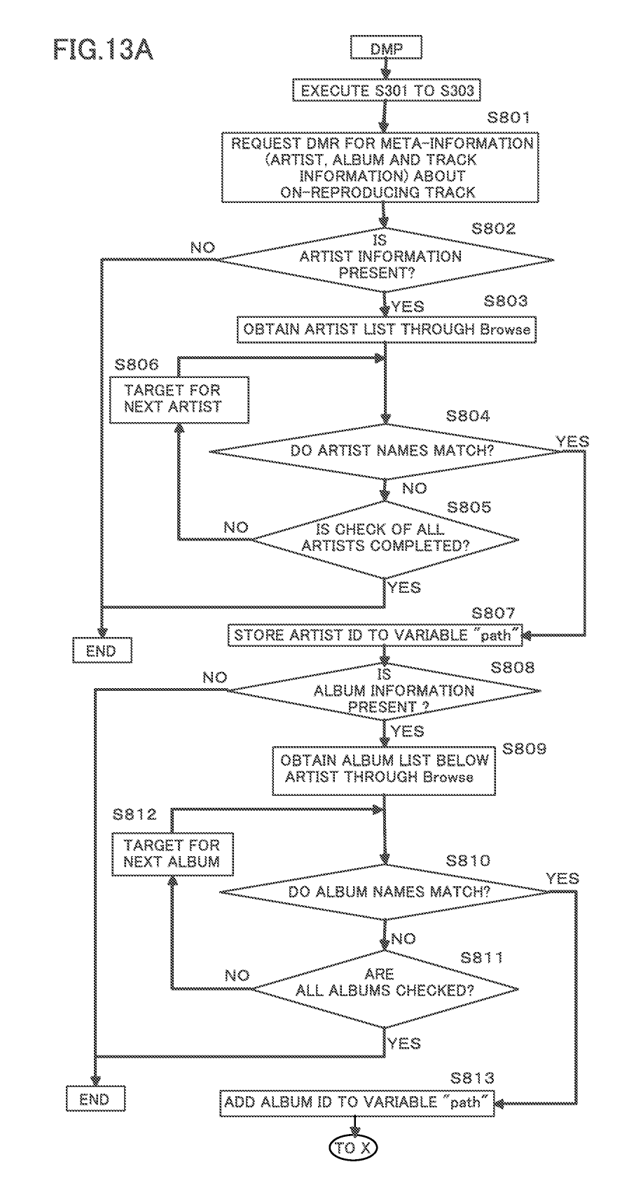

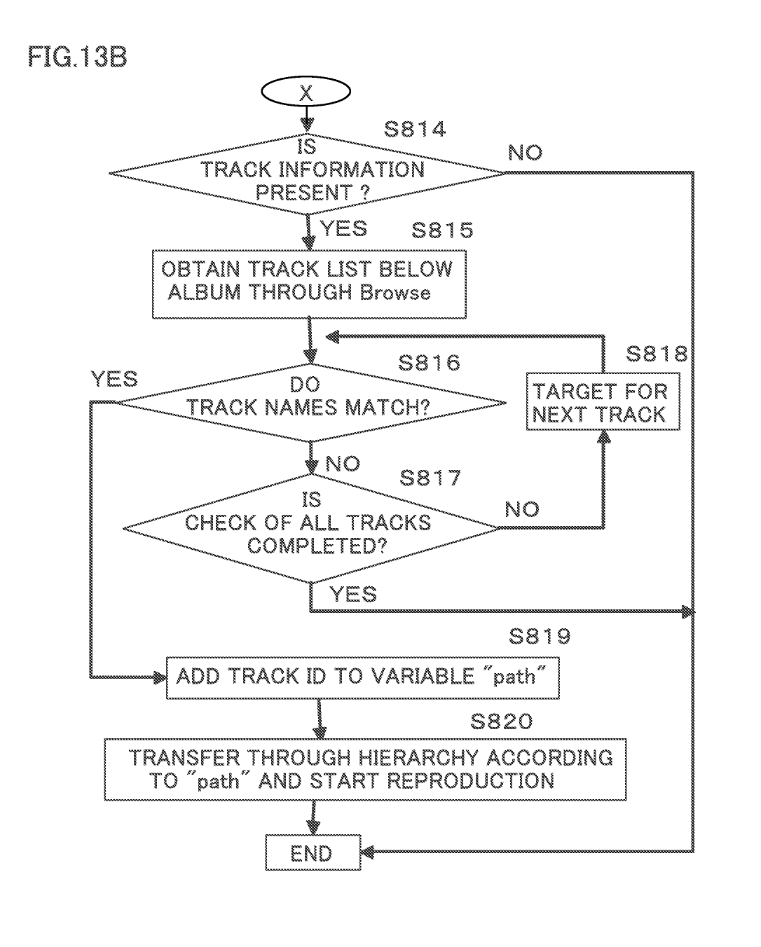

FIG. 13 (FIG. 13A and FIG. 13B) is a flowchart illustrating the DMP 100A2 according to the fourth embodiment. When a content identical to the content being reproduced by the DMR 100A1 is instructed to be reproduced, the DMP 100A2 in the fourth embodiment specifies an artist hierarchy and an album hierarchy to which the specified content belongs, and automatically moves between the hierarchical levels so as to reproduce the content. For this reason, the user can easily obtain the album and the artist of the content in the DMP 100A2.

The DMP 100A2 executes the processes in S301 to S303 described in FIG. 6. The DMP 100A2 requests the DMR 100A1 for information about the content being reproduced by the DMR 100A1 (S801). The DMP 100A2 requests for artist information, album information, and track information about the content being reproduced by the DMR 100A1.

The DMP 100A2 determines whether the artist information is included in information obtained from the DMR 100A1 in S801 (S802). When the determination is made that the artist information is not included (NO in S802), the process is ended, and when the determination is made that the artist information is included (YES in S802), the DMP 100A2 requests the DMS 300 for the artist list (S803). That is, the DMP 100A2 obtains the artist list below All Artists in FIG. 12.

The DMP 100A2 compares the artist information obtained in S801 with each artist name in the artist list obtained in S803 (S804). When the determination is made that the artist names match (YES in S804), the DMP 100A2 stores a content ID in a variable “path”. When the determination is made that the artist names do not match (NO in S804), the DMP 100A2 determines whether the process in S804 is executed on all the artists obtained in S803 (S805). When the determination is made that all the artists are checked (YES in S805), the process is ended, and when the determination is made that not all the artists are checked (NO in S805), the DMP 100A2 executes the process after S804 on the next artist in the artist list. The value set to “path” by the process in S807 is “1.2”, for example, when the matched artist is Artist B in FIG. 12.

The DMP 100A2 determines whether the content information obtained by the process in S801 includes album information (S808). When the determination is made that the album information is not included (NO in S808), the DMP 100A2 ends the process, and when the determination is made that the album information is included (YES in S808), the DMP 100A2 obtains from the DMS 300 an album list in a lower hierarchical level below the artist specified by the process in S804 (S809). For example, when Artist B is specified by the process in S804, the DMP 100A2 obtains an album list below Artist B.

Similarly to the process on the artist name, the DMP 100A2 determines whether a folder having the album name identical to the album name obtained in S801 is present in the album list obtained in S809 (S810), and when the determination is made that the album name is identical (YES in S810), the DMP 100A2 adds a content ID of the matched album folder to the variable “path” (S813). When the determination is made that the album name is not identical (NO in S810), the DMP 100A2 determines whether the process in S810 is executed on all the album folders obtained in S809 (S811). When the determination is made that all the album folders are checked (YES in S811), the DMP 100A2 ends the process, and when the determination is made that not all the album folders are checked (NO in S811), the DMP 100A2 targets for the next album folder (S812). For example, when Album B1 is specified in S810 in FIG. 12, “path” is set to “1.2.1” by the process in S813.

The DMP 100A2 determines whether the content information obtained by the process in S801 includes track information (S814). When the determination is made that the track information is not included (NO in S814), the process is ended, and when the determination is made that the track information is included (YES in S814), the DMP 100A2 obtains from the DMS 300 a track list in a lower hierarchical level below the album specified by the process in S810 (S815).

The DMP 100A2 determines whether a content having the track name identical to the track name obtained in S801 is present in the track list obtained in S815 (S816), and when the determination is made that the track names match, (YES in S816), the DMP 100A2 adds a content ID to the variable “path” (S819). When the determination is made that the track names do not match (NO in S816), the DMP 100A2 determines whether the process in S816 is executed on all the tracks obtained in S815 (S817). When the determination is made that all the tracks are checked (YES in S817), the process is ended, and when the determination is made that not all the tracks are checked (NO in S817), the DMP 100A2 targets for the next track (S818). For example, when Track B11 in FIG. 12 is specified in S816, the “path” is set to “1.2.1.1” by the process in S819.

The DMP 100A2 automatically moves between the hierarchical levels (FIG. 12) of the content folder in the DMS 300 based on the ID set to the “path”, and starts to reproduce the content (S820). When the value of the “path” is “1.2.1.1”, the DMP 100A2 accesses to All Artists, Artist B, Album A1, and Track B11 in FIG. 12 in this order.

According to the fourth embodiment, when the DMR 100A1 is instructed to reproduce a content identical to the on-reproducing content, the DMP 100A2 automatically specifies the artist hierarchy and the album hierarchy to which the instructed content belongs, and automatically moves between the hierarchical levels of the DMS 300 so as to reproduce the content. Therefore, the user can easily obtain another album or the like of the artist to which the content being reproduced by the DMR 100A1 belongs. The fourth embodiment illustrates an example using an artist name and an album name, but another tag information such as a genre name and a date on which a content is released may also be used. For example, when a genre name is used, the DMP 100A2 automatically moves to a folder of a genre identical to the genre to which the content being reproduced by the DMR 100A1 belongs so as to reproduce the content.

[Fifth Embodiment in which DMP Starts to Reproduce Content Identical to that of DMR]

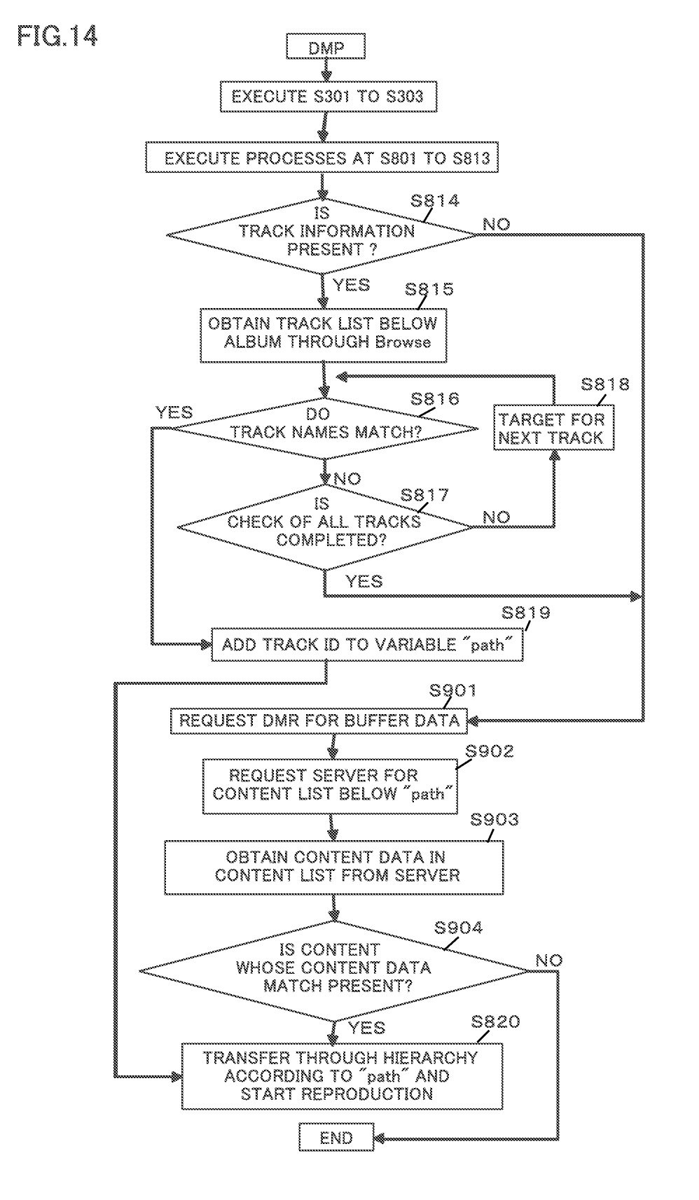

FIG. 14 is a flowchart illustrating the DMP 100A2 according to the fifth embodiment. Even when the DMP 100A2 in the fifth embodiment cannot obtain track information from the DMR 100A1, the DMP 100A2 specifies a content being reproduced by the DMR 100A1 as well as information about a folder including the content. In FIG. 14, the same processes as in FIG. 13 are denoted by the same reference symbols, and descriptions thereof will be omitted.

The DMP 100A2 executes the process in S301 to S303, and further executes the process in S801 to S813. The DMP 100A2 determines whether track information in content information obtained by the process in S801 is normally set (S814).

When the determination is made that the track information is not obtained (NO in S814), the DMP 100A2 requests the DMR 100A1 for content data about the on-reproducing content (S901). The DMP 100A2 then requests the DMS 300 for a content list below the folder specified by the value currently set to the variable “path” (S902). Since the value that can specify an album is set to the “path” by the processes in S807 and S813, the DMP 100A2 can specify the album folder based on the “path”. For example, when the “path” is set to “1.2.1”, the DMP 100A2 obtains a track list in a lower hierarchical level below Album B1 in FIG. 12.

The DMP 100A2 obtains content data of contents in the track list obtained in S902 from the DMS 300 (S903), and determines whether a content having content data matching with the content data obtained in S901 is present (S904). When the determination is made that the matched content is present (YES in S904), the process in S820 is executed, and when the determination is made that the matched content is not present (NO in S904), the process is ended.

According to the fifth embodiment, even when a part of information obtained from the DMR100A2 in S801 is missing, the DMP 100A2 can specify a content being reproduced by the DMR 100A1. Even when not only track information but also album information is missing in S801, the DMP 100A2 executes the process in S902 to S904 on all tracks below the artist folder, so as to be capable of specifying a content as well as hierarchical information.

The preferred embodiments of the present invention have been described above, but the present invention is not limited to these embodiments. The content data may be video data or still image data. Further, after the DMP 100A2 specifies a content identical to that of the DMR 100A1, the DMR 100A1 and the DMP 100A2 reproduce the contents according to the different content lists. However, the DMP 100A2 may reproduce the content identical to the content being reproduced by the DMR 100A1. In this case, every time when the DMP 100A2 completes reproduction of one content, the process in FIG. 6 or FIG. 8 is executed.

What is claimed is:

1. An audio output apparatus, comprising:
a media renderer for obtaining and reproducing a content of a server based on a control command transmitted from a controller according to a user's operation; and
a media player for obtaining and reproducing the content of the server based on an instruction input by the user, wherein
the media renderer includes a unit for receiving location information of the content of the server from the controller and obtaining the content from the server based on the location information so as to reproduce the content,
the media player includes
a unit for obtaining a content list of the server selected by the user's operation,
a reproducing unit for obtaining the content selected from the content list by the user's operation from the server so as to reproduce the content,
a unit for accepting an identical content reproducing instruction that is an instruction for reproducing the content identical to the content being reproduced by the media renderer,
a content information obtaining unit for obtaining, from the media renderer, content information of the content being reproduced by the media renderer when the identical content reproducing instruction is accepted, and
an identical content specifying unit for searching the content list for a content identical to the content being reproducing by the media renderer based on the content information and specifying a position of the content in the content list, and
the reproducing unit reproduces the content specified by the identical content specifying unit.

2. The audio output apparatus according to claim 1, further comprising:
a first output section for outputting content data being reproduced by the media player to a first content receiving device installed in a first room; and
a second output section for outputting the content data being reproduced by the media renderer to a second content receiving device installed in a second room, wherein
when the media player accepts the identical content reproducing instruction, the reproducing unit outputs the content specified by the identical content specifying unit to the first content receiving device.

3. The audio output apparatus according to claim 1, wherein
the content information is meta-information of the content,
the media player further includes a determining unit for comparing the meta-information of each of the contents in the content list with the meta-information obtained from the media renderer to determine whether the meta-information match with each other when the identical content reproducing instruction is accepted, and
the identical content specifying unit specifies a position of the content whose meta-information is determined as matching in the content list.

4. The audio output apparatus according to claim 3, wherein
the content information includes folder meta-information as the meta-information about one or a plurality of content folders and content meta-information as the meta-information about the content included in a content folder in a lowest hierarchical level,
the media player further includes
a folder list obtaining unit for obtaining a content folder list from the server,
a content folder determining unit for comparing the meta-information about the content folders in the content folder list with the folder meta-information obtained from the media renderer to determine whether the meta-information match with each other,
an identical content folder specifying unit for specifying a position of the content folder whose meta-information is determined as matching in the folder list, and
a content path storage unit for storing the position of the content folder specified by the identical content folder specifying unit into a content path,
the determining unit compares the meta-information about the contents included in the lowest content folder with the content meta-information obtained from the media renderer to determine whether the meta-information match with each other,
the identical content specifying unit specifies a position of the content whose meta-information is determined as matching in the content list,
the content path storage unit stores the position of the content specified by the identical content specifying unit into the content path,
the reproducing unit moves to the content folder of the server specified by the content path to reproduce the content.

5. The audio output apparatus according to claim 4, wherein
the media player further includes
a content meta-information missing determining unit for determining whether the content information includes the content meta-information, and
a content data obtaining unit for, when the identical content reproducing instruction is accepted, obtaining from the media renderer at least part of the content data of the content being reproduced by the media renderer,
when the determination is made that the content meta-information is missing, at least part of the content data of the respective contents included in the lowest content folder is obtained from the server,
the determining unit compares a reproducing waveform of the content data of the content obtained from the server with a reproducing waveform of the content data obtained from the media renderer to determine whether the content data match with each other, and
the identical content specifying unit specifies a position of the content whose content data is determined as matching in the content list.

6. A media renderer program stored on a non-transitory computer readable medium for causing the audio output apparatus according to claim 1 to execute the respective units of the media renderer in the audio output apparatus.

7. A media player program stored on a non-transitory computer readable medium for causing the audio output apparatus according to claim 1 to execute the respective units of the media player in the audio output apparatus.

8. A method of an audio output apparatus, the audio output apparatus comprising:
a media renderer for obtaining and reproducing a content of a server based on a control command transmitted from a controller according to a user's operation; and
a media player for obtaining and reproducing the content of the server based on an instruction input by the user,
the method includes:
a step for receiving location information of the content of the server from the controller and obtaining the content from the server based on the location information so as to reproduce the content in the media renderer,
a step for obtaining a content list of the server selected by the user's operation in the media player,
a reproducing step for obtaining the content selected from the content list by the user's operation from the server so as to reproduce the content in the media player,
a step for accepting an identical content reproducing instruction that is an instruction for reproducing the content identical to the content being reproduced by the media renderer in the media player,
a content information obtaining step for obtaining, from the media renderer, content information of the content being reproduced by the media renderer when the identical content reproducing instruction is accepted in the media player, and
an identical content specifying step for searching the content list for a content identical to the content being reproducing by the media renderer based on the content information and specifying a position of the content in the content list in the media player, and
the reproducing step reproduces the content specified by the identical content specifying step.
